(19) United States
(12) Patent Application Publication
(10) Pub. No.: US 2017/0351157 A1
(43) Pub. Date: Dec. 7, 2017

(54) HIGH-CONTRAST PHOTONIC CRYSTAL "OR," "NOT" AND "XOR" LOGIC GATE

(71) Applicant: Zhengbiao Ouyang, Shenzhen (CN)

(72) Inventors: Zhengbiao Ouyang, Shenzhen (CN); Quanqiang Yu, Shenzhen (CN)

(21) Appl. No.: 15/626,218

(22) Filed: Jun. 19, 2017

Related U.S. Application Data
(63) Continuation of application No. PCT/CN2015/097846, filed on Dec. 18, 2015.

(30) Foreign Application Priority Data
Dec. 19, 2014 (CN) 201410797514.4

(51) Int. Cl. G02F 3/00; G02B 6/122; G02B 6/125; G02F 1/365

(52) U.S. Cl. CPC G02F 3/00; G02F 1/365; G02B 6/1225; G02B 6/1223; G02B 6/125; G02F 2201/06; G02F 2202/32

(57) ABSTRACT

The present invention discloses an high-contrast photonic crystal “OR”, “NOT” and “XOR” logic gate, comprising a six-port two-dimensional photonic crystal, a nonlinear cavity unit and a cross-waveguide logic gate unit; the high-contrast photonic crystal “OR” logic gate includes a first reference-light input port, two first idle ports, two first signal-input ports and a first signal-output port; the high-contrast photonic crystal “NOT” logic gate includes two second reference-light input ports, two second idle ports, a second signal-input port and a second signal-output port; and the high-contrast photonic crystal “XOR” logic gate includes a three reference-light input port, two three-idle ports, two three-signal input ports and a three-signal output port; the cross-waveguide logic gate unit is arranged with different input or output ports; and the nonlinear cavity unit is coupled with the cross-waveguide logic gate unit. The structure of the present invention is easy to integrate with other optical logic elements.

### CROSS-REFERENCE TO RELATED APPLICATION

This application is a continuation application of PCT Application No. PCT/CN2015/097846 filed on Dec. 18, 2015 which claims priority to Chinese Application No. 201410797514.4 filed on Dec. 19, 2014, the entire contents of which are hereby incorporated by reference.

### FIELD OF THE INVENTION

The present invention relates generally to two-dimensional (2D) photonic crystals (PhCs), nonlinear optics and optical “OR,” “NOT” AND “XOR” logic gates.

### BACKGROUND OF THE INVENTION

In 1987, the concept of PhC was proposed separately by E. Yablonovitch from United States Bell Labs who discussed how to suppress spontaneous radiation and by S. John from Princeton University who made discussions about photonic localization. A PhC is a material structure in which dielectric materials are arranged periodically in space, and is usually an artificial crystal comprising of two or more materials having different dielectric constants.

With the emergence of and in-depth research on PhC, people can control the motion of photons in a PhC material more flexibly and effectively. In combination with traditional semiconductor processes and integrated circuit technologies, design and manufacture of PhC and devices thereof have continually and rapidly marched towards all-optical processing, and PhC has become a breakthrough for photonic integration. In December 1999, PhC was recognized by the American influential magazine Science as one of the top-ten scientific advances in 1999, and therefore has become a hot topic in today's scientific research field.

An all-optical logic device mainly includes an optical amplifier-based logic device, a non-linear loop mirror logic device, a Sagnac interference type logic device, a ring cavity logic device, a multi-mode interference logic device, an optical waveguide coupled logic device, a photoisomerized logic device, a polarization switch optical logic device, a transmission grating optical logic device, etc. These optical logic devices have the common shortcoming of large size in developing large-scale integrated optical circuits. With the improvement of science and technology in recent years, people have also done research and developed quantum optical logic devices, nano material optical logic devices and PhC optical logic devices, which all conform to the dimensional requirement of large-scale photonic integrated optical circuits. For modern manufacturing processes, however, the quantum optical logic devices and the nano material optical logic devices are very difficult to be manufactured, whereas the PhC optical logic devices have competitive advantages in terms of manufacturing process.

In recent years, PhC logic devices have become a hot area of research drawing widespread attentions, and it is highly likely for them to replace the current widely-applied electronic logic devices in the near future.

### SUMMARY OF THE INVENTION

The present invention is aimed at overcoming the defects of the prior art and providing a high-contrast PhC “OR”, “NOT” and “XOR” logic gate which is compact in structure, high in contrast of the high and low logic output, and easy to integrate with other optical logic elements.

In order to solve the above technical problems, the present invention adopts the following technical solution:

A high-contrast PhC “OR”, “NOT” and “XOR” logic gate, wherein the high-contrast PhC “OR”, “NOT” and “XOR” logic gate is a structure of six-port 2D PhC, comprising a nonlinear cavity unit and a cross-waveguide logic gate unit; said high-contrast PhC “OR” logic gate includes a first reference-light input port, two first idle ports, two first signal-input ports and a first signal-output port; said high-contrast PhC “NOT” logic gate includes two second reference-light input ports, two second idle ports, a second signal-input port and a second signal-output port; and said high-contrast PhC “XOR” logic gate includes a third reference-light input port, two third idle ports, two third signal-input ports and a third signal-output port; the cross-waveguide logic gate unit is arranged with different input or output ports; and the nonlinear cavity unit is coupled with the cross-waveguide logic gate unit.

The nonlinear cavity unit is a 2D PhC cross-waveguide nonlinear cavity, including a fourth reference-light input port, an intermediate signal-input port, a fourth signal-output port and a fourth idle port.

The intermediate signal-input port of the nonlinear cavity unit is connected with the second and the third signal-output ports of the “NOT” logic gate and the “XOR” logic gate of the cross-waveguide logic gate unit respectively.

The intermediate signal-input port of the nonlinear cavity unit is connected with the first signal-output port of the “OR” logic gate of the cross-waveguide logic gate unit.

The high-refractive-index linear-dielectric pillars of the nonlinear cavity unit constitute a 2D PhC cross intersected waveguide four-port network, a left port of said four-port network is the fourth reference-light input port, a lower port of said four-port network is the intermediate signal-input port, an upper port of said four-port network is the fourth signal-output port, and a right port of said four-port network is the fourth idle port; two mutually-orthogonal quasi-one-dimensional (quasi-1D) PhC structures are placed in two waveguide directions crossed at the center of across waveguide, a dielectric pillar is arranged in the middle of the cross waveguide, the dielectric pillar is made of a nonlinear material, the cross section of the dielectric pillar is square, polygonal, circular or oval; the dielectric constant of a rectangular linear pillar clinging to the central nonlinear pillar and close to the signal-output port is equal to that of the central nonlinear pillar under low-light-power conditions; and the quasi-1DPhC structures and the dielectric pillar constitute a waveguide defect cavity.

The refractive index of a dielectric pillar in a quasi-1DPhC of the cross waveguide of the nonlinear cavity unit is 3.4 or a different value more than 2; and the refractive index of the dielectric pillar has the cross section shape of square.

The cross-waveguide logic gate unit is the cross-waveguide PhC “OR”, “NOT” and “XOR” logic gate; and said cross-waveguide logic gate unit includes two signal-input ports, a signal-output port and an idle port.

The cross-waveguide logic gate unit is a PhC of a four-port waveguide network, the right port and lower port of the four-port network are respectively a fifth reference-light input port and a fifth signal-input ports or two signal-input ports, and the left port and upper port are respectively fifth idle ports or fifth signal-output ports; and a circular dielectric pillar is arranged in the cross center of the four-port network.

The high-refractive-index linear-dielectric pillar of the 2D PhC and has a cross section of circular, polygonal, triangle or oval.

The background filling material for the 2D PhC is air or a different low-refractive-index medium having a refractive index less than 1.4.

The PhC logic device of the present invention can be widely applied to optical communication bands by scaling the structure. Compared with the prior art, it has the following advantages:

1. Compact in structure, and ease of integration with other optical logic elements;

2. The PhC logic device can directly carry out all-optical logic functions of “AND”, “OR”, “NOT” and the like, is a core device for realizing all-optical computing;

3. Through the amplitude transform characteristic of the nonlinear cavity, not only can the functions of the high-contrast PhC “OR”, “NOT” and “XOR” logic gate be realized, but also the contrast of high and low logic output is high; and

4. Strong in anti-interference capability and high in computing speed.

These and other objects and advantages of the present invention will become readily apparent to those skilled in the art upon reading the following detailed description and claims and by referring to the accompanying drawings.

### BRIEF DESCRIPTION OF THE DRAWINGS

The present invention is more specifically described in the following paragraphs by reference to the drawings attached only by way of example.

FIG. 1 is a structural diagram of a high-contrast PhC “NOT” and “XOR” logic gate of the present invention.

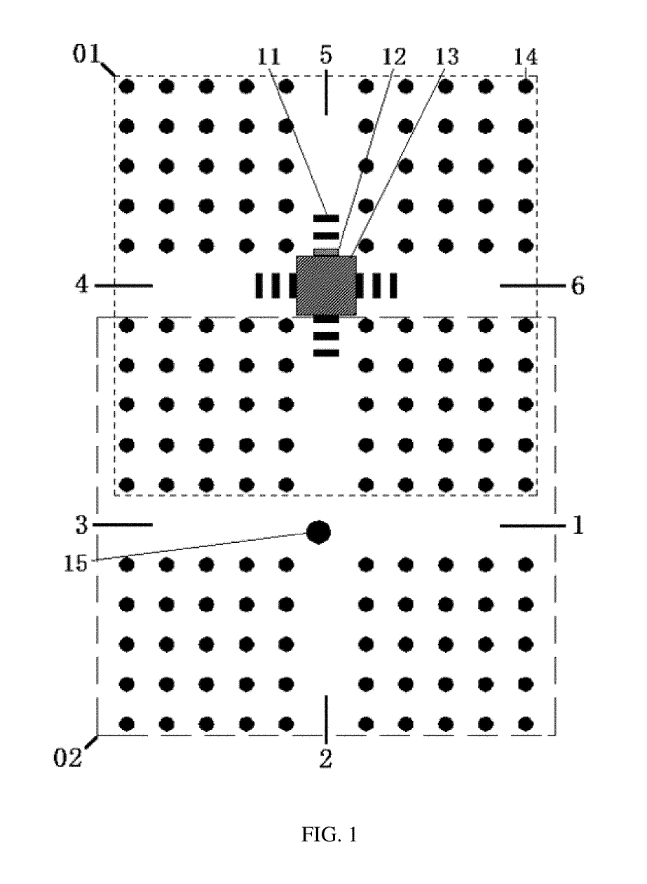

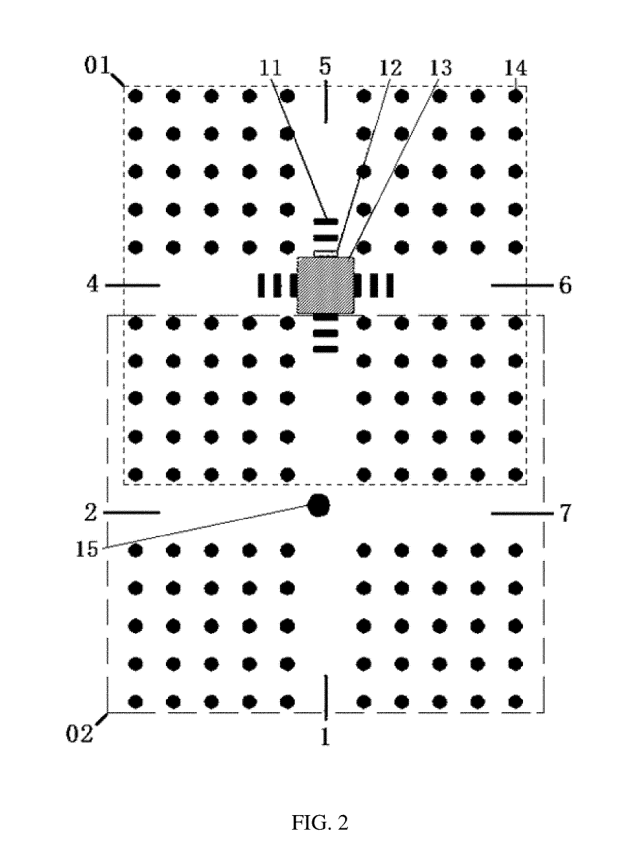

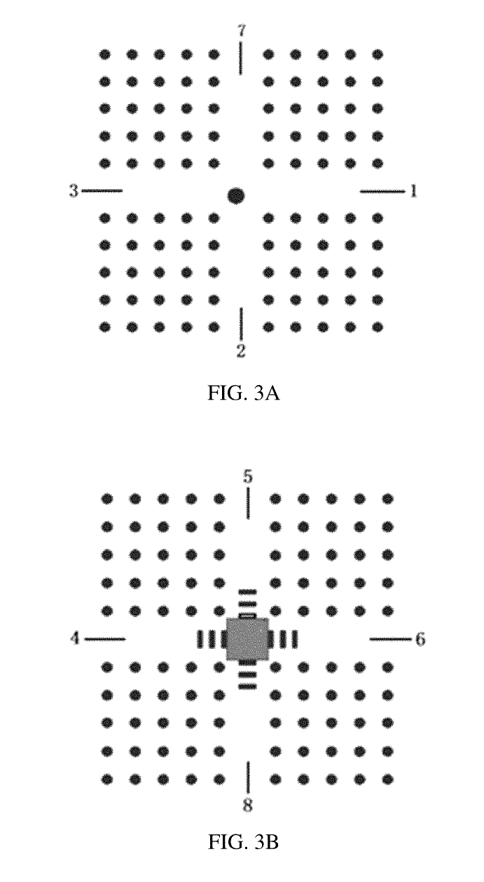

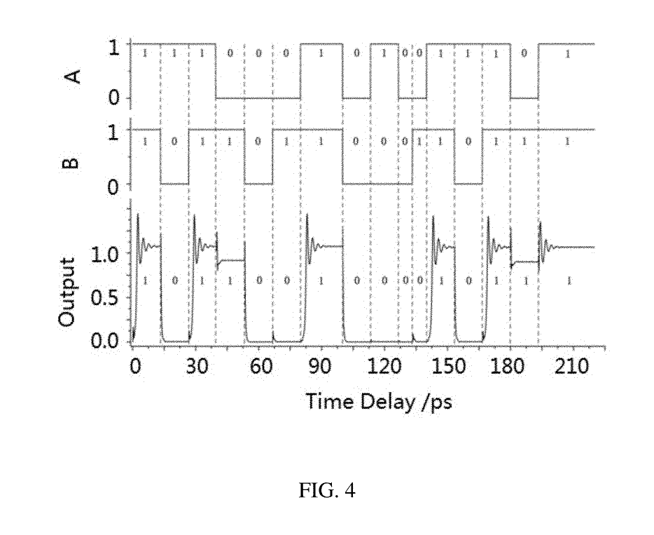

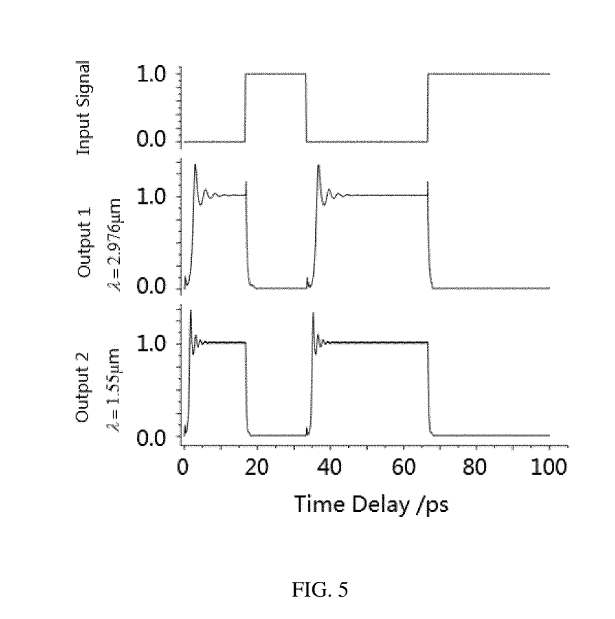

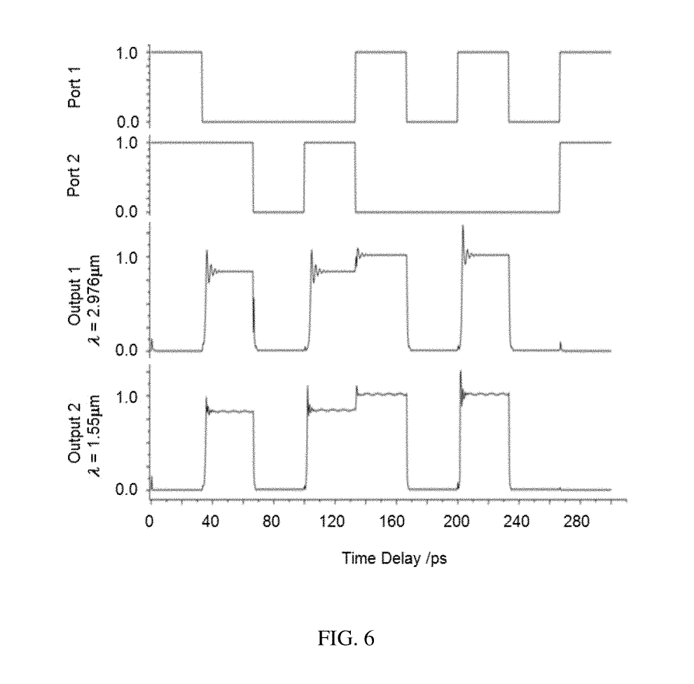

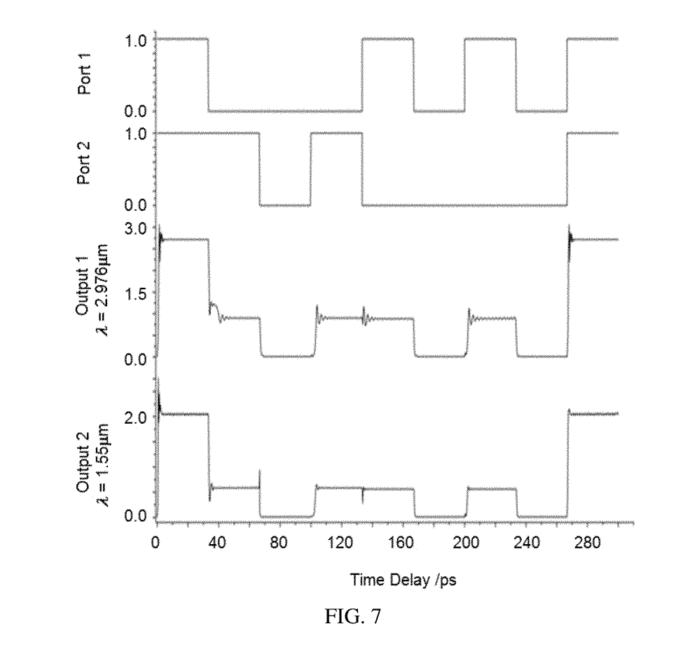

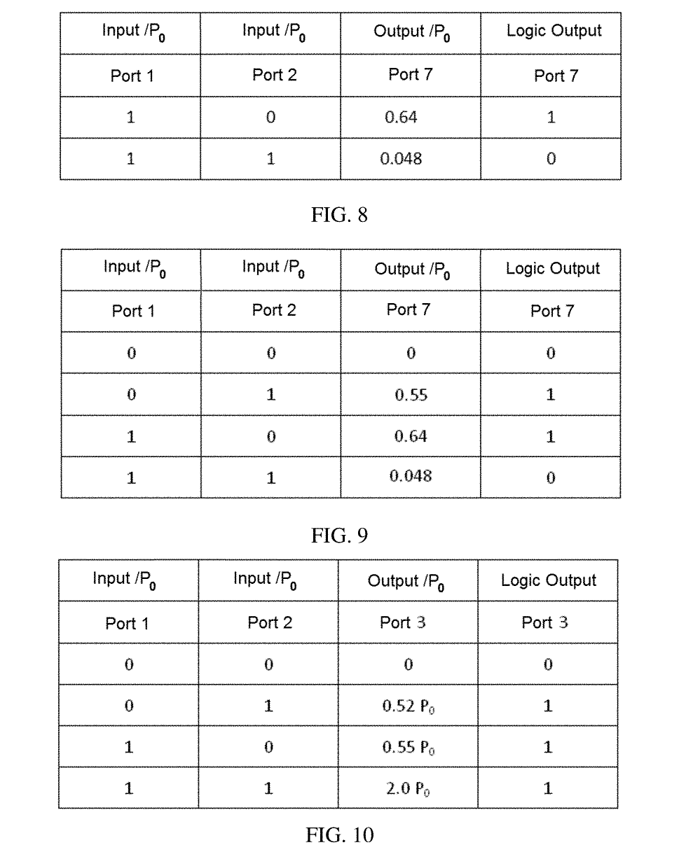

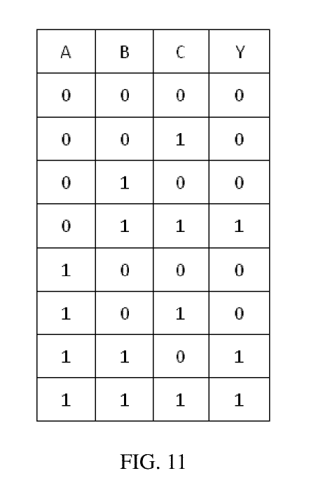

In FIG. 1, indications are: nonlinear cavity unit 01, cross-waveguide logic gate unit 02 second reference-light input port 1, second signal-input port 2, second idle port 3, second reference-light input port 4, second signal-output port 5 and second idle port 6 of “NOT” logic gate of third signal-input port 1, third signal-input port 2, third idle port 3, third reference-light input port 4, third signal-output port 5 and third idle port 6 of “XOR” logic gate of first rectangular high-refractive-index linear-dielectric pillar 11, second rectangular high-refractive-index linear-dielectric pillar 12, square nonlinear-dielectric pillar 13, circular high-refractive-index linear-dielectric pillar 14, circular linear-dielectric pillar 15

FIG. 2 is a structural diagram of a high-contrast PhC “OR” logic gate of the present invention.

In FIG. 2, wherein indicated are: nonlinear cavity unit 01, cross-waveguide logic gate unit 02, first signal-input port 1, first signal-input port 2, first idle port 3, first reference-light input port 4, first signal-output port 5, first idle port 6, first idle port 7, first rectangular high-refractive-index linear-dielectric pillar 11, second rectangular high-refractive-index linear-dielectric pillar 12, square nonlinear-dielectric pillar 13, circular high-refractive-index linear-dielectric pillar 14, circular linear-dielectric pillar FIGS. 3A and 3B is a structural diagram of two units of a high-contrast PhC “OR”, “NOT” and “XOR” logic gate of the present invention.

In FIG. 3A, wherein indicated are: second reference-light input port 1, second signal-input port 2, second idle port 3 and second signal-output port 7 of “NOT” logic gate of cross-waveguide logic gate unit 02, third signal-input port 1, third signal-input port 2, third idle port 3 and third signal-output port 7 of “XOR” logic gate of cross-waveguide logic gate unit 02, first signal-input port 1, first signal-input port 2, first signal-output port 3 and first idle port 7 of “OR” logic gate of cross-waveguide logic gate unit 02.

In FIG. 3B, wherein indicated are: fourth reference-light input port 4, intermediate signal-input port 8, fourth signal-output port 5 and fourth idle port 6 of nonlinear cavity unit 01.

FIG. 4 is a waveform diagram of basic logic functions of output of the signal “output port 5” of the nonlinear cavity unit 01 shown in FIG. 3B.

FIG. 5 is a waveform diagram of a high-contrast “NOT” logic operation function realized by the high-contrast PhC “NOT” logic gate shown in FIG. 1.

FIG. 6 is a waveform diagram of a high-contrast “XOR” logic operation function realized by the high-contrast PhC “XOR” logic gate shown in FIG. 1.

FIG. 7 is a waveform diagram of a high-contrast “OR” logic operation function realized by the high-contrast PhC OR logic gate shown in FIG. 2.

FIG. 8 is an input and output relation table of the “NOT” logic gate of the cross-waveguide logic gate unit shown in FIG. 3A.

FIG. 9 is an input and output relation table of the “XOR” logic gate of the cross-waveguide logic gate unit shown in FIG. 3A.

FIG. 10 is an input and output relation table of the “OR” logic gate of the cross-waveguide logic gate unit shown in FIG. 3A.

FIG. 11 is a truth table of logic functions of the nonlinear cavity unit shown in FIG. 3B.

The present invention is more specifically described in the following paragraphs by reference to the drawings attached only by way of example.

### DETAILED DESCRIPTION OF THE EMBODIMENTS

The terms a or an, as used herein, are defined as one or more than one, The term plurality, as used herein, is defined as two or more than two. The term another, as used herein, is defined as at least a second or more.

The high-contrast PhC “OR”, “NOT” and “XOR” logic gate of the present invention is a structure of six-port 2D PhC, and comprises a nonlinear cavity unit 01 and a cross-waveguide logic gate unit 02; FIG. 1 shows the high-contrast PhC “NOT” and “XOR” logic gates, wherein the high-contrast PhC “NOT” logic gate includes two second reference-light input ports, a second signal-input port, a second signal-output port and two second idle ports; the high-contrast PhC “XOR” logic gate includes a third reference-light input port, two third signal-input ports, a third signal-output port and two third idle ports; and the high-contrast PhC “OR” logic gate shown in FIG. 2 includes a first reference-light input port, two first signal-input ports, a first signal-output port and two first idle ports.

The cross-waveguide logic gate unit 02, as shown in FIG. 3A, is a cross waveguide PhC optical “OR”, “NOT” and “XOR” logic gate, can perform logic operation on input signals, and can realize “OR”, “NOT” and “XOR” logic functions respectively by setting different input or output ports; the cross-waveguide logic gate unit 02 is a PhC of a four-port waveguide network, and includes a fifth reference-light input port and a signal-light input ports or two signal-input ports, a fifth signal-output port and a fifth idle port; the right port and lower port of the four-port network are respectively a fifth reference-light input port and a signal-light input port or two signal-input ports, and the left port and upper port are respectively fifth idle ports or fifth signal-output ports; a circular dielectric pillar is arranged nearby the center of the cross intersected waveguide of the four-port network, it is supposed that the center of symmetry of the cross intersected waveguide is an origin (0, 0), the circle center of the circular dielectric pillar in the center is at the position (−0.188d, −0.188d), and the radius is 0.292d.

As shown in FIG. 3A, port 1 and port 2 are first signal-input ports, port 3 is a first signal-output port, port 7 is a first idle port, and thus the unit realizes an “OR” logic operation function of two input signals, as shown in FIG. 10.

As shown in FIG. 3A, port 1 is a second reference-light input port to which reference-light E (E=P₀) is input, port 2 is a second signal-input port, port 7 is a second signal-output port, port 3 is a second idle port, and thus the unit realizes a “NOT” logic operation function of input signals, as shown in FIG. 8.

As shown in FIG. 3A, port 1 and port 2 are third signal-input ports, port 7 is a third signal-output port, port 3 is a third idle port, and thus the unit realizes an “XOR” logic operation function of two input signals, as shown in FIG. 9.

Hence, the cross-waveguide logic gate unit shown in FIG. 3A realizes “OR”, “NOT” and “XOR” logic operation functions of logic input signals.

The nonlinear cavity unit 01, as shown in FIG. 3B, is a 2D PhC cross-waveguide nonlinear cavity, and realizes set logic functions by using the preceding-stage logic output as a logic input according to the logic operation characteristics itself. The nonlinear cavity unit 01 includes a fourth reference-light input port, an intermediate signal-input port, a fourth signal-output port and a fourth idle port; high-refractive-index linear-dielectric pillars of the nonlinear cavity unit 01 shown in FIG. 1 constitute a 2D PhC cross intersected waveguide four-port network, the left port of the four-port network is the fourth reference-light input port, the lower port is the intermediate signal-input port, the upper port is the fourth signal-output port, and the right port is the fourth idle port. The lattice constant of the 2D PhC array is d, and the array number is 11×11; two mutually-orthogonal quasi-1DPhC structures are placed in two waveguide directions crossed at the center of across waveguide, a dielectric pillar is arranged in the middle of the cross waveguide, the dielectric pillar is made of a nonlinear material, the cross section of the dielectric pillar is square, polygonal, circular or oval; the dielectric constant of a rectangular linear pillar clinging to the central nonlinear pillar and close to the signal-output port is equal to that of the central nonlinear-dielectric pillar under low-light-power conditions; and the quasi-1D PhC structures and the dielectric pillar constitute a waveguide defect cavity. Twelve rectangular high linear-dielectric pillars and one square nonlinear-dielectric pillar are arranged in the center of the 2D PhC cross-waveguide nonlinear cavity in the form of a quasi-1D PhC along longitudinal and transverse waveguide directions, the central nonlinear-dielectric pillar clings to the four adjacent rectangular linear-dielectric pillars and the distance therebetween is 0, every two adjacent rectangular linear-dielectric pillars are spaced 0.2668d from each other, the first rectangular high-refractive-index linear-dielectric pillar 11 of the nonlinear cavity unit 01 and has a refractive index of 3.4, the second rectangular high-refractive-index linear-dielectric pillar 12 is a dielectric constant of 7.9, and has a dielectric constant being the same as that of a nonlinear-dielectric pillar under low-light-power conditions, square nonlinear-dielectric pillar 13 is made of a Kerr type nonlinear material, and has a dielectric constant of 7.9 under low-light-power conditions; the circular high-refractive-index linear-dielectric pillar 14 is made of a silicon (Si) material, and has a refractive index of 3.4.

The present invention based on the photonic bandgap characteristic, quasi-1DPhC defect state, tunneling effect and optical Kerr nonlinear effect of the PhC nonlinear cavity unit 01 shown in FIG. 3B. In combination with the logic operation characteristics of the cross-waveguide logic gate unit 02 shown in FIG. 3A, the nonlinear cavity unit 01 realizes high-contrast PhC “OR”, “NOT” and “XOR” logic gate functions.

The basic principle of the PhC nonlinear cavity unit 01 in the present invention: a 2D PhC provides a Photonic Band Gap (PBG) with certain bandwidth, a light wave with its wavelength falling into this bandgap can be propagated in an optical circuit designed inside the PhC, and the operating wavelength of the device is thus set to certain wavelength in the PBG shown in FIG. 3B. the quasi-1D PhC structure arranged in the center of the cross waveguide and the nonlinear effect of the central nonlinear-dielectric pillar together provide a defect state mode, which, as the input light wave reaches a certain light intensity, shifts to the operating frequency of the system, so that the structure produces the tunneling effect and signals are output from the output port 5.

For the lattice constant d of 1 μm and the operating wavelength of 2.976 μm, referring to the 2D PhC cross-waveguide nonlinear cavity 01 shown in FIG. 3B, and for a signal A is input from the port 4 and a signal B is input from the port 8 shown by the upper two diagrams in FIG. 4, the logic output waveforms are obtained and indicated at the lower part in FIG. 4. A logic operation truth table of the structure shown in FIG. 3B can be obtained according to the logic operation characteristic shown in FIG. 4, as illustrated in FIG. 11. In FIG. 11, C is current state Qⁿ, and Y is signal output of the fourth output port 5 of the nonlinear cavity unit 01, i.e., the next state Qⁿ⁺¹. A logic expression of the nonlinear cavity unit can be obtained according to the truth table.

Y=AB+BC (1)

That is

Qⁿ⁺¹=AB+BQⁿ (2)

As the cross waveguide logic gate unit having a “NOT” logic gate structure as shown in FIG. 3A is coupled with the nonlinear cavity unit shown in FIG. 3B, the second output port 7 of the cross-waveguide “NOT” logic gate shown in FIG. 3A is connected with the intermediate signal-input port 8 of the nonlinear cavity unit 01 shown in FIG. 3B, i.e., the output signal of the “NOT” logic gate is used as the input signal of the input port 8 of the nonlinear cavity unit 01, as shown in FIG. 1. In FIG. 1, for reference-light E₁ and E₂ (E₁=E₂=1) are respectively input to the port 1 and the port 4, and a signal S₁ is input to the port 2, according to the logic operation characteristic of the “NOT” logic gate of the cross-waveguide logic gate unit 02 and the logic expression (2) of the nonlinear cavity unit 01, the output of the output port 5 of the structure shown in FIG. 1 can be obtained:

Qⁿ⁺¹=S̅₁̅ (3)

wherein, S̅₁̅ is a high-contrast “NOT” logic signal, and the structure shown in FIG. 1 can realize a “NOT” logic operation function of input signals.

In the same way, for the cross-waveguide logic gate unit having a “XOR” logic gate structure as shown in FIG. 3A is coupled with the nonlinear cavity unit shown in FIG. 3B, the third output port 7 of the cross-waveguide “XOR” logic gate shown in FIG. 3A is connected with the intermediate signal-input port 8 of the nonlinear cavity unit 01 shown in FIG. 3B, i.e., the output signal of the “XOR” logic gate is used as the input signal of the intermediate signal-input port 8 of the nonlinear cavity unit 01, as shown in FIG. 1. In FIG. 1, for reference-light E (E₁=1) is input to the port 4, a signal C₁ is input to the port 1, and a signal C₂ is input to the port 2, according to the logic operation characteristic of the “XOR” logic gate of the cross-waveguide logic gate unit 02 and the logic expression (2) of the nonlinear cavity unit 01, the output of the output port 5 of the structure shown in FIG. 1 can be obtained:

Qⁿ⁺¹=C₁⊕C₂ (4)

Hence, the structure shown in FIG. 1 can realize an “XOR” logic operation function of two input signals. It can be obtained in combination with formula (3) and formula (4) that the same structure shown in FIG. 1 can realize a “NOT” logic operation function and an “XOR” logic operation function respectively by setting different inputs.

In the same way, as the cross-waveguide logic gate unit 02 having a “OR” logic gate structure as shown in FIG. 3A is coupled with the nonlinear cavity unit shown in FIG. 3B, the first output port 3 of the cross-waveguide “OR” logic gate shown in FIG. 3A is connected with the intermediate signal-input port 8 of the nonlinear cavity unit 01 shown in FIG. 3B, i.e., the first output signal of the “OR” logic gate is used as the input signal of the intermediate signal-input port 8 of the nonlinear cavity unit, as shown in FIG. 2. In FIG. 2, for reference-light E (E=1) is input to the port 4, a signal D₁ is input to the port 1, and a signal D₂ is input to the port 2, according to the logic operation characteristic of the “OR” logic gate of the cross-waveguide logic gate unit 02 and the logic expression (2) of the nonlinear cavity unit 01, the output of the output port 5 of the structure shown in FIG. 2 can be obtained:

Qⁿ⁺¹=D₁+D₂ (5)

Thus, the structure shown in FIG. 2 can realize an “OR” logic operation function of two input signals.

The PhC structure of the device of the present invention is a (2m+1)×(2n+1) array structure, where m is an integer more than or equal to 5, and where n is an integer more than or equal to 8, Design and simulation results will be provided below in an embodiment given in combination with the accompanying drawings, wherein the embodiment is exemplified by an 11×17 array structure, and design and simulation results are given, taking the lattice constant d of the 2D PhC array being 1 μm and 0.5208 μm respectively as an example.

### Embodiment 1

Referring to that shown in FIG. 1, the lattice constant d is 1 μm; the operating wavelength is 2.976 μm; the radius of the circular high-refractive-index linear-dielectric pillar 14 is 0.18 μm; the long sides of the first rectangular high-refractive-index linear-dielectric pillar 11 are 0.613 μm, and the short sides are 0.1621 μm; the size of the second rectangular high-refractive-index linear-dielectric pillar 12 is the same as that of the first rectangular high-refractive-index linear-dielectric pillar 11; the side length of the square nonlinear-dielectric pillar 13 is 1.5 μm, and the third-order nonlinear coefficient is 1.33×10⁻² μm²/V²; and the distance between every two adjacent rectangular linear-dielectric pillars is 0.26681 μm; the radius of the circular linear-dielectric pillar 15 is 0.292 μm; Referring to the structure shown in FIG. 1, reference-light E₁ and E₂ are respectively input to the port 1 and the port 4, wherein E₁=E₂=1; an Input Signal shown in FIG. 5 is input to the port 2, a high-contrast PhC “NOT” logic operation output signal can be obtained, as shown by “Output 1” in FIG. 5, and the high and low logic contrast of the output signal is more than 10 dB.

In the same way, referring to that shown in FIG. 1, the lattice constant d is 0.5208 μm; the operating wavelength is 1.55 μm; the radius of the circular high-refractive-index linear-dielectric pillar 14 is 0.0937 μm; the long sides of the first rectangular high-refractive-index linear-dielectric pillar 11 are 0.3193 μm, and the short sides are 0.0844 μm; the size of the second rectangular high-refractive-index linear-dielectric pillar 12 is the same as that of the first rectangular high-refractive-index linear-dielectric pillar 11; the side length of square nonlinear-dielectric pillar 13 is 0.7812 μm, and the third-order nonlinear coefficient is 1.33×10⁻² μm²/V²; and the distance between every two adjacent rectangular linear-dielectric pillars is 0.1389 μm; the radius of the circular linear-dielectric pillar 15 is 0.0937 μm. FIG. 1, reference-light E₁ and E₂ are respectively input to the port 1 and the port 4, wherein E₁=E₂=1; an Input Signal shown in FIG. 5 is input to the port 2, a high-contrast PhC “NOT” logic operation output signal can be obtained, as shown by “Output 2” in FIG. 5, and the high and low logic contrast of the output signal is more than 21 dB.

Hence, the structure shown in FIG. 1 can realize a high-contrast PhC “NOT” logic operation function, and can adjust the operating wavelengths to optical communication bands by scaling.

### Embodiment 2

Referring to that shown in FIG. 1, the lattice constant d is 1 μm; the operating wavelength is 2.976 μm; the radius of the circular high-refractive-index linear-dielectric pillar 14 is 0.18 μm; the long sides of the first rectangular high-refractive-index linear-dielectric pillar 11 are 0.613 μm, and the short sides are 0.162 μm; the size of the second rectangular high-refractive-index linear-dielectric pillar 12 is the same as that of the first rectangular high-refractive-index linear-dielectric pillar 11; the side length of square nonlinear-dielectric pillar 13 is 1.5 μm, and the third-order nonlinear coefficient is 1.33×10⁻² μm²/V²; and the distance between every two adjacent rectangular linear-dielectric pillars is 0.2668 μm; the radius of the circular nonlinear-dielectric pillar 15 is 0.292 μm. Referring to the structure shown in FIG. 1, reference-light E is input to the port 4, wherein E=1; port 1 and port 2 signals shown in FIG. 6 are respectively input to the port 1 and the port 2, a high-contrast PhC “XOR” logic operation output signal can be obtained, as shown by “Output 1” in FIG. 6, and the high and low logic contrast of the output signal is more than 19 dB.

In the same way, referring to that shown in FIG. 1, the lattice constant d is 0.5208 μm; the operating wavelength is 1.55 μm; the radius of the circular high-refractive-index linear-dielectric pillar 14 is 0.0937 μm; the long sides of the first rectangular high-refractive-index linear-dielectric pillar 11 are 0.3193 μm, and the short sides are 0.0844 μm; the size of the second rectangular high-refractive-index linear-dielectric pillar 12 is the same as that of the first rectangular high-refractive-index linear-dielectric pillar 11; the side length of square nonlinear-dielectric pillar 13 is 0.7812 μm, and the third-order nonlinear coefficient is 1.33×10⁻² μm²/V²; and the distance between every two adjacent rectangular linear-dielectric pillars is 0.1389 μm; the radius of the circular linear-dielectric pillar 15 is 0.0937 μm.

Referring to the structure shown in FIG. 1, reference-light E is input to the port 4, wherein E=1; port 1 and port 2 signals shown in FIG. 6 are respectively input to the port 1 and the port 2, a high-contrast PhC “XOR” logic operation output signal can be obtained, as shown by “Output 2” in FIG. 6, and the high and low logic contrast of the output signal is more than 23 dB.

Hence, the structure shown in FIG. 1 can realize a high-contrast PhC “XOR” logic operation function, and can adjust the operating wavelengths to optical communication bands by scaling.

It can be obtained by comparing with embodiment 1 that the structure shown in FIG. 1 can realize a high-contrast PhC “NOT” logic gate and a high-contrast PhC “XOR” logic gate respectively by different setting of the input ports.

### Embodiment 3

Referring to that shown in FIG. 2, the lattice constant d is 1 μm; the operating wavelength is 2.976 μm; the radius of the circular high-refractive-index linear-dielectric pillar 14 is 0.18 μm; the long sides of the first rectangular high-refractive-index linear-dielectric pillar 11 are 0.613 μm, and the short sides are 0.162 μm; the size of the second rectangular high-refractive-index linear-dielectric pillar 12 is the same as that of the first rectangular high-refractive-index linear-dielectric pillar 11; the side length of square nonlinear-dielectric pillar 13 is 1.5 μm, and the third-order nonlinear coefficient is 1.33×10⁻² μm²/V²; and the distance between every two adjacent rectangular linear-dielectric pillars is 0.2668 μm; the radius of the circular linear-dielectric pillar 15 is 0.292 μm.

Referring to the structure shown in FIG. 1, reference-light E is input to the port 4, wherein E=1; port 1 and port 2 signals shown in FIG. 7 are respectively input to the port 1 and the port 2, a high-contrast PhC “OR” logic operation output signal can be obtained, as shown by “Output 1” in FIG. 7, and the high and low logic contrast of the output signal is more than 19 dB.

In the same way, referring to that shown in FIG. 1, the lattice constant d is 0.5208 μm; the operating wavelength is 1.55 μm; the radius of the circular high-refractive-index linear-dielectric pillar 14 is 0.0937 μm; the long sides of the first rectangular high-refractive-index linear-dielectric pillar 11 are 0.3193 μm, and the short sides are 0.0844 μm; the size of the second rectangular high-refractive-index linear-dielectric pillar 12 is the same as that of the first rectangular high-refractive-index linear-dielectric pillar 11; the side length of square nonlinear-dielectric pillar 13 is 0.7812 μm, and the third-order nonlinear coefficient is 1.33×10⁻² μm²/V²; and the distance between every two adjacent rectangular linear-dielectric pillars is 0.1389 μm; the radius of the circular linear-dielectric pillar 15 is 0.0937 μm.

Referring to the structure shown in FIG. 2, reference-light E is input to the port 4, wherein E=1; port 1 and port 2 signals shown in FIG. 7 are respectively input to the port 1 and the port 2, a high-contrast PhC “OR” logic operation output signal can be obtained, as shown by “Output 2” in FIG. 7, and the high and low logic contrast of the output signal is more than 17 dB.

Hence, the structure shown in FIG. 2 can realize a high-contrast PhC “OR” logic operation function, and can adjust the operating wavelengths to optical communication bands by scaling.

While the invention has been described in terms of various specific embodiments, those skilled in the art will recognize that the invention can be practiced with modification within the spirit and scope of the claims.

What is claimed is:

1. A high-contrast photonic crystal (PhC) “OR”, “NOT” and “XOR” logic gate, wherein said high-contrast PhC “OR”, “NOT” and “XOR” logic gate is a structure of six-port two-dimensional (2D) PhC, comprising:
a nonlinear cavity unit and a cross-waveguide logic gate unit; said high-contrast PhC “OR” logic gate includes a first reference-light input port, two first idle ports, two first signal-input ports and a first signal-output port; said high-contrast PhC “NOT” logic gate includes two second reference-light input ports, two second idle ports, a second signal-input port and a second signal-output port; and said high-contrast PhC “XOR” logic gate includes a third reference-light input port, two third idle ports, two third signal-input ports and a third signal-output port; said cross-waveguide logic gate unit is arranged with different input or output ports; and said nonlinear cavity unit is coupled with the cross-waveguide logic gate unit.

2. The high-contrast PhC “OR”, “NOT” and “XOR” logic gate in accordance with claim 1, wherein said nonlinear cavity unit is a 2D PhC cross-waveguide nonlinear cavity, and includes a fourth reference-light input port, an intermediate signal-input port, a fourth signal-output port and a fourth idle port.

3. The high-contrast PhC “OR”, “NOT” and “XOR” logic gate in accordance with claim 1, wherein said intermediate signal-input port of said nonlinear cavity unit is connected with said second and the third signal-output ports of said “NON” logic gate and said “XOR” logic gate of said cross-waveguide logic gate unit respectively.

4. The high-contrast PhC “OR”, “NOT” and “XOR” logic gate in accordance with claim 1, wherein said intermediate signal-input port of said nonlinear cavity unit is connected said first signal-output port of said “OR” logic gate of said cross-waveguide logic gate unit.

5. The high-contrast PhC “OR”, “NOT” and “XOR” logic gate in accordance with claim 1, wherein a high-refractive-index linear-dielectric pillars of said nonlinear cavity unit constitute a 2D PhC cross intersected waveguide four-port network, a left port of said four-port network is the fourth reference-light input port, a lower end of said four-port network is the intermediate signal-input port, an upper end of said four-port network is the fourth signal-output port, and a right end of said four-port network is the fourth idle port; two mutually-orthogonal quasi-one-dimensional (1D) PhC structures are placed in the two waveguide directions crossed at the center of a cross waveguide, a dielectric pillar is arranged in the middle of the cross waveguide, the dielectric pillar is made of a nonlinear material, the cross section of the dielectric pillar is square, polygonal, circular or oval; the dielectric constant of the rectangular linear pillar clinging to the central nonlinear pillar and close to the signal-output port is equal to that of the central nonlinear-dielectric pillar under low-light-power conditions; and the quasi-1D PhC structures and the dielectric pillar constitute a waveguide defect cavity.

6. The high-contrast PhC “OR, “NOT” and “XOR” logic gate in accordance with claim 1, wherein said refractive index of a dielectric pillar in a quasi-1D PhC of the cross waveguide of the nonlinear cavity unit is 3.4 or a different value more than 2; and said refractive index of the dielectric pillar has the cross section shape of square.

7. The high-contrast PhC “OR”, “NOT” and “XOR” logic gate in accordance with claim 1, wherein said cross-waveguide logic gate unit is the cross-waveguide PhC “OR”, “NOT” and “XOR” logic gate; and said cross-waveguide logic gate unit is included of two signal-input ports, a signal-output port and an idle port.

8. The high-contrast PhC “OR”, “NOT” and “XOR” logic gate in accordance with claim 1, wherein said cross-waveguide logic gate unit is a PhC of a four-port waveguide network, the right end and lower end of the four-port network are respectively a fifth reference-light input end and a fifth signal-input ports or two signal-input ends, and the left end and upper end are respectively fifth idle ports or fifth signal-output ends; and a circular dielectric pillar is arranged in the cross center of the four-port network.

9. The high-contrast PhC “OR”, “NOT” and “XOR” logic gate in accordance with claim 1, wherein said high-refractive-index linear-dielectric pillar of the 2D PhC has a cross section of circular, polygonal, triangle or oval.

10. The high-contrast PhC “OR”, “NOT” and “XOR” logic gate in accordance with claim 1, wherein a background filling material for the 2D PhC is air or a different low-refractive-index medium having a refractive index less than 1.4.
